(19) United States
(12) Patent Application Publication
(10) Pub. No.: US 2016/0191268 A1
(43) Pub. Date: Jun. 30, 2016

(54) Interchangeable Modular Home Automation System

(71) Applicant: Ryan N. Diebel, Littleton, CO (US)

(72) Inventor: Ryan N. Diebel, Littleton, CO (US)

(21) Appl. No.: 14/829,270

(22) Filed: Aug. 18, 2015

Related U.S. Application Data
(60) Provisional application No. 62/038,596, filed on Aug. 18, 2014.

(51) Int. Cl. H04L 12/28; H04L 29/08

(52) U.S. Cl. CPC H04L 12/2818; H04L 12/2823; H04L 67/10; H04L 2012/2843

(57) ABSTRACT

Interchangeable modular systems for home networking are provided. The systems may contain home energy and appliance monitors controls, and/or home security/surveillance systems. In particular, the systems may use existing electrical gang or junction boxes to house said systems, which may have a high degree of interchangeability or modularity. These systems have useful features in, e.g., the residential home environment and office or industrial buildings. More specifically, modular home automation devices comprising a gang-box microcomputer having a main processor, a communications module, and at least one functional module are provided. Also provided herein are devices for home automation and control comprising a gang-box microcomputer having a form factor fitting inside an existing electrical junction box.

### CROSS-REFERENCE TO RELATED APPLICATIONS

This application claims priority to U.S. Provisional Patent Application No. 62/038,596, filed Aug. 18, 2014, hereby incorporated in its entirety.

### FIELD OF THE INVENTION

This invention generally relates to the field of home automation systems for homes and buildings, including but not limited to interchangeable modular systems for home networking, home energy and appliance controls, and/or home security/surveillance systems, and in particular the use of existing electrical gang or junction boxes to house said systems, which may have a high degree of interchangeability or modularity. Although many features of this invention will be described in relation to a residential home environment, they are also useful in other applications, including but not limited to office and industrial building applications.

### BACKGROUND OF THE INVENTION

The 1933-1934 World's Fair of Chicago featured “The House of Tomorrow,” an exhibit focused on “smart home” and home automation technologies. The event provided a view to the future of homes, exhibiting automated dishwashers, dimmer switches and passive solar heating.

From the 1930's, the home automation and controls market continually developed as new technologies advanced. Until the 1970s, consumers viewed home automation and related smart-home technologies as luxuries for use by hobbyists willing to pave their own way as well as the wealthy willing to pay top-dollar. A major break-through, however, came about with the invention of the micro-controller in the 1970s. This development reduced home control technology costs down to an attainable price point for many consumers. While the micro-controller enabled more affordable automated control of appliances, not until more recently has the utilization of such technologies become commonplace. Automated systems and devices primarily for use in the home did not become a household norm until the late 1990s and early 2000s. Many home systems including HVAC control, sprinkler systems, and alarm systems, became microcontroller-driven systems during this time frame.

More recently, home automation technology has caught up with breakthroughs associated with consumer technology products. A variety of technologies, ranging from small format portable Wifi-enabled computers to smart-phone technology, have dramatically increased the options for connectivity and communication with and among home systems. These technologies have enabled a new level of home automation and system control. However, standardization, interoperability and modularity remain challenges and yet to be solved problems among the variety of inventions related to state of the art home automation technologies.

Much of the latest prior art in the field of home automation and control use smart-phone technologies. Such technologies allow users to control, communicate and monitor a variety of home systems, including lights, HVAC, alarms, doors, windows, door-bells, phone systems and environmental sensors. Whether a user prefers a preprogrammed system, active control or a self-learning system, a smart phone enables a user of such a system to have a great deal of control and oversight of home automation systems from virtually anywhere in the world.

A problem associated with home automation and control is that many products in the prior art related to home automation require the pre-wiring of a structure embodying such products, or in relation to, to enable the use of such products. Many products cannot easily be removed for use in other locations within a house or in conjunction with other products, such as smart phones. As a result, home automation products known in the prior art typically require complicated installation. For instance, security cameras or thermostatic sensors traditionally require power and communication wire installations. The necessity of these wires often requires that the installation take place prior to construction so that the requisite wiring may be installed beneath sheathing material such as drywall. In existing homes, such installation would require the specialized and time-consuming task of routing a wire through existing wall cavities and structural members. Alternatively, in some cases, one must completely remove such wall sheathing, adding to the time, expense and inconvenience associated with properly outfitting an existing home with home automation systems known in the prior art.

Many products associated with the provision of added functionality in the capacity of home-automation and systems control provide such functionality through permanently installed and hard wire devices. Generally, the installation of these devices takes place during the construction of the physical structure housing the home automation system. Unfortunately, the level of integration with a house associated with the desired magnitude of home automation and systems control does not represent a financially sensible option for most existing home owners. As a result, some products have solved the problem of the need for hardwiring by providing plug-in units. These plug-in units for sensors or actuators are typically housed in plastic and mush be hung on a wall, set on a shelf. They can be battery powered, which creates a problem of battery-life and replacement, or need to be plugged into a receptacle to provide power to the device. The problem with plug-in units is that they are often cumbersome and unsightly. Furthermore, this leaves the user with the inconvenience of less available power outlets for use.

Some recent products associated with home automation known in the prior art provide users with the ability to retrofit their homes using hard-wired or plug-in units to enable increased home system control and automation capabilities. Problems associated with such units include that they are cumbersome and unsightly. For example, many of these units use large power converters to bring the power from a standard 110 v AC power to a 12V DC power. These converters, sometimes called “wall-warts”, hang off a wall-outlet and are very conspicuous. This is not only unsightly to some users, but also defeats the purpose of a seamless integration of automated home systems products. This is particularly true in the case of security-related systems, which may be compromised by their conspicuousness. Moreover, such security-related home automated systems and devices known in the prior art that rely on such plug-in integrations or wall-warts can be easily circumvented by intruders simply by unplugging them.

Some other examples in the field of home automation and control known in the prior art allow a user to retrofit an existing home without the need for permanently connected wiring for communication between units and a central control unit. A “central control unit” is also referred to herein to as a “hub-unit.” Often, such devices allow a user to have multiple points of functionality with a given unit. The problem with such examples of prior art is that such systems do not allow a user to change the functionality without replacing the entire unit. Further still, the units are designed with predetermined functionality so a user does not have the option to customize to their own wants and needs. For example, some devices known in the prior art associated with home automation and smart-home technology use existing junction boxes to incorporate a variety of functionalities, including environmental or occupancy sensors. A problem associated with such devices, however, is that the functionalities associated with them are fixed. For instance, if a user wishes to change functionality, that user must purchase a new unit. Such devices do not allow for the alteration of their functionalities. Moreover, such devices do not allow their users to have the option of changing existing electrical service point, such as swapping out a toggle switch for a dimmer switch. The service point is hard wired into such items leaving the user unable to swap in an outlet, light-switch, ground-fault circuit interrupt (GFCI) outlet or other electrical service point without purchasing an entire new unit.

Furthermore, some items in the field of home automation and control known in the prior art offer some level of modularity, but such items require the user to purchase a specialized outlet rather than use the existing outlet. For example, one prior art technology integrates modular functionality into a GFCI outlet unit through the use of functional modules. These functional modules are of small form factor units that plug directly into a receiving slot integrated into the outlet itself As such, if a user of such item desired functionality of environmental sensing such as a thermostatic sensor, the user would need to purchase a functional module enabling such ability and plug it directly into the specifically designed receptacle to further integrate into a larger intranet of home control and automation. The problem with such functionality lies in the form factor of the outlet itself. This provides limited functionality available to the user as the form-factor of an electrical service point has limited space available for such modularity. Therefore, the user of such an item faces problems associated with limitations with the amount of functionality he or she may combine with any given installation of such a unit. Such an item also requires its user to purchase more outlet units to increase the functionality within their home. Furthermore, an inherent problem associated with the integration of such a unit into an outlet is that it takes up a high proportion of space typically utilized with a power outlet, junction box, or similar device. As such, such a system may limit the number of electrical service points available. In the case of an outlet, such an item may reduce the number of outlets from two to one.

The present inventor realized that a variety of challenges associated with the field of home automation and control remain to be solved. The present invention addresses these and other previously unsolved problems.

### BRIEF DESCRIPTION OF THE FIGURES

FIG. 1A. Electrical Outlet found in the prior art (6)

FIG. 1B. Gang Box found in the prior art (12)

FIG. 1C. Gang-Box Microcomputer (1) front view in preferred embodiment

FIG. 1D. Gang-Box Microcomputer (1) front view with a prior art Electrical Outlet (6) installed within prior art Gang Box (12) in preferred embodiment

FIG. 2A. Three-quarters view of Electrical Outlet found in the prior art (6) in preferred embodiment

FIG. 2B. Three quarters view of the Gang-Box Microcomputer (1) installed within Gang Box found in the prior art (12) in preferred embodiment

FIG. 2C. Three-quarters view of the Gang-Box Microcomputer (1) with a prior art Electrical Outlet (6) installed within prior art Gang Box (12) in preferred embodiment

FIG. 3A. Front view of Gang-Box Microcomputer (1) with functional module receptacles/recesses (3) in the preferred embodiment of the invention

FIG. 3B. Side view of Gang-Box Microcomputer (1) with functional module receptacles/recesses (3), Gang-Box Microcomputer Microprocessor (11), and optional Communications Module (19) in the preferred embodiment of the invention

FIG. 4A. Three-quarters view of the Cover Plate with Module Apertures (4)

FIG. 4B. Three-quarters view of the Gang-Box Microcomputer (1) with functional Modules (2) and Cover Plate with Module Apertures in relation to a cross-sectional view of a wall (7) and wall stud (8)

FIG. 5A. Three-quarters view of the Module Concealer Cover Plate (9), in the open position, and Gang-Box Microcomputer (1)

FIG. 5B. Three-quarters view of the closed Module Concealer Cover Plate (10) embodiment and Gang-Box Microcomputer (1) in relation to a cross-sectional view of a wall (7) in one embodiment of the invention

FIG. 5C. Three quarters view of the open Module Concealer Cover Plate (9) and Gang-Box Microcomputer (1) with Functional Modules (2) in Gang Box (12), shown in relation to a cross-sectional view of a wall (7) in one embodiment of the invention

FIG. 6. Side view of Gang-Box Microcomputer (1) and Cover-Plate with Module Apertures (3), functional modules (2), and Cosmetic Block-Offs (5)

FIG. 7A. Front view of alternate embodiment of Gang-Box Microcomputer integrated into Gang-Box (13)

FIG. 7B. Front view of alternate embodiment of Gang-Box Microcomputer integrated into Gang-Box (13) with a prior art electrical outlet (6)

FIG. 8A. Singular Controller Box (14) front view in an embodiment of the invention

FIG. 8B. Front view Singular Controller Box (14) embodiment with a prior art Gang Box (12) and electrical outlet (6)

FIG. 9A. Three quarters view of the Plug-in Gang-Box Microcomputer (16) embodiment with electrical plugs (17), electrical outlets (18), and functional module receptacles/recesses (3)

FIG. 9B. Three quarters view of embodiments of the Cosmetic Block-Off Cover Plate for Functional Module Apertures (28)

FIG. 9C. Three quarters view of the Plug-in Integrated Gang-Box Microcomputer (16) embodiment with cosmetic block-off cover plate (28) in relation to a wall (7) and electrical outlet (6) found in the prior art

FIG. 10. Gang Controller System embodiment with Communications Module (19), Router found in prior art (22), Wireless Signal Emitter found in the prior art (21), Hub Unit (20), Wireless Signal (23), Gang-Box Microcomputer (1), and Gang-Box Microcomputer Endpoint embodiment (24).

FIG. 11A. Three quarters view of the Light-socket microcomputer (25) embodiment

FIG. 11B. Three quarters exploded view of the Light-socket microcomputer (25) embodiment with functional modules (2), light socket (26), and light bulb (27)

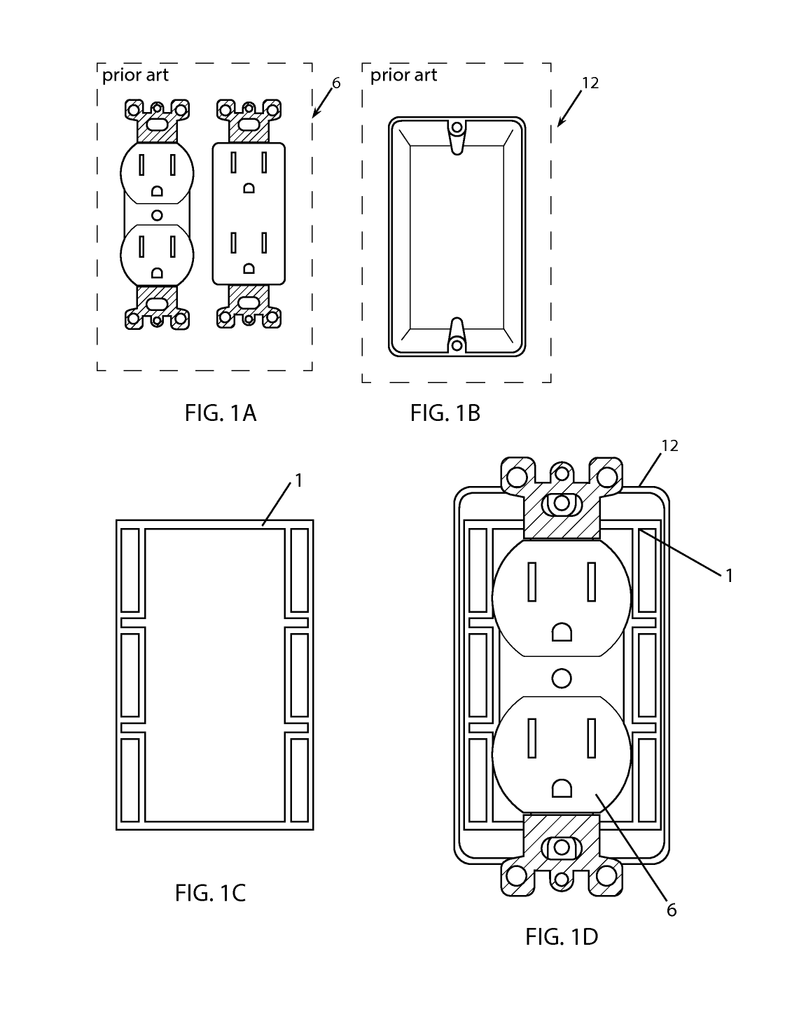

### SUMMARY

At the heart of the invention is a device that incorporates standardized ports to enable connectivity of interchangeable smart home or home automation devices. In the preferred embodiment of the invention, the system makes use of existing electrical infrastructure of a home, including junction boxes or gang-boxes, that typically house one or more electrical service components, such as a light switch or a power outlet. The preferred embodiment of the invention does so in a manner to allow the continued traditional service or electrical control from existing infrastructure, such a junction box with existing components, while enabling modularity and concealment of such added home automation functions.

The preferred embodiment the invention comprises a gang-box microcomputer 1 with a form factor sized to fit within a standard junction box without displacing the existing service or control such as an outlet or switch. The gang-box microcomputer 1 comprises a main processor, a communications module, and functional modules. In the preferred embodiment, the functional modules are covered by a faceplate, the faceplate having a form factor so as to permit the installation and exchange of functional modules functional modules to provide at least one added function. Such functions include, but are not limited to, environmental sensing devices, audio/video recording devices, monitoring and power shut-off devices. One such device, or a plurality of such devices, provides status, data and other information to a hub-unit, controllable by a user. Said gang-box microcomputer provides sensing capabilities including but not limited to sensing the surrounding environment, communicating with a hub-unit processing or control unit. The gang-box microcomputer 1 in the main embodiment communicates with a base station. Furthermore, the hub-unit provides communication with a network or cloud-based system to provide remote control of the system

### DETAILED DESCRIPTION

At the heart of the invention is an apparatus that enables home automation and control, with modularity associated with home automation hardware, by integrating plug-and-play units within the existing infrastructure of a building.

Many of the benefits associated with home automation and control systems stem from their ability to sense the environment of the home. Sensing the environment provides valuable information to a smart-home or home automation system. The metrics generated from the sensing enable more precise control associated with the home automation and control system associated with the preferred embodiment of the invention. The inventor has solved the problem of modularity and interchangeability associated with the variety of evolving sensing devices by developing the mechanisms described herein to accommodate the presently known variety of sensing mechanisms and also the yet-to-be-developed sensing mechanisms within a standardized form factor.

Sensing as defined within this document includes but is not limited to environmental sensing, visual sensing, auditory sensing and physical sensing. It will be appreciated by one skilled in the art, that environmental sensing includes but is not limited to monitoring and communication of data associated with temperature, humidity, barometric pressure, weather changes, chemical or gas detection, air quality, smoke and other gasses. It also will be appreciated by one skilled in the art that visual sensing includes but is not limited to monitoring and communication of data associated with cameras, motion-detection, depth-sensing, light intensity and wavelength and UV levels.

It will be appreciated by one skilled in the art that auditory sensing includes but is not limited to sensing and communication of sound-based data associated with the use of recording devices such as microphones to detect and record sound based information both audible to humans as well as those inaudible such as RF frequencies.

Furthermore, it will be appreciated by one skilled in the art that physical sensing includes but is not limited to the monitoring and communication data associated with contact pressure, structural integrity and seismic activity within a building.

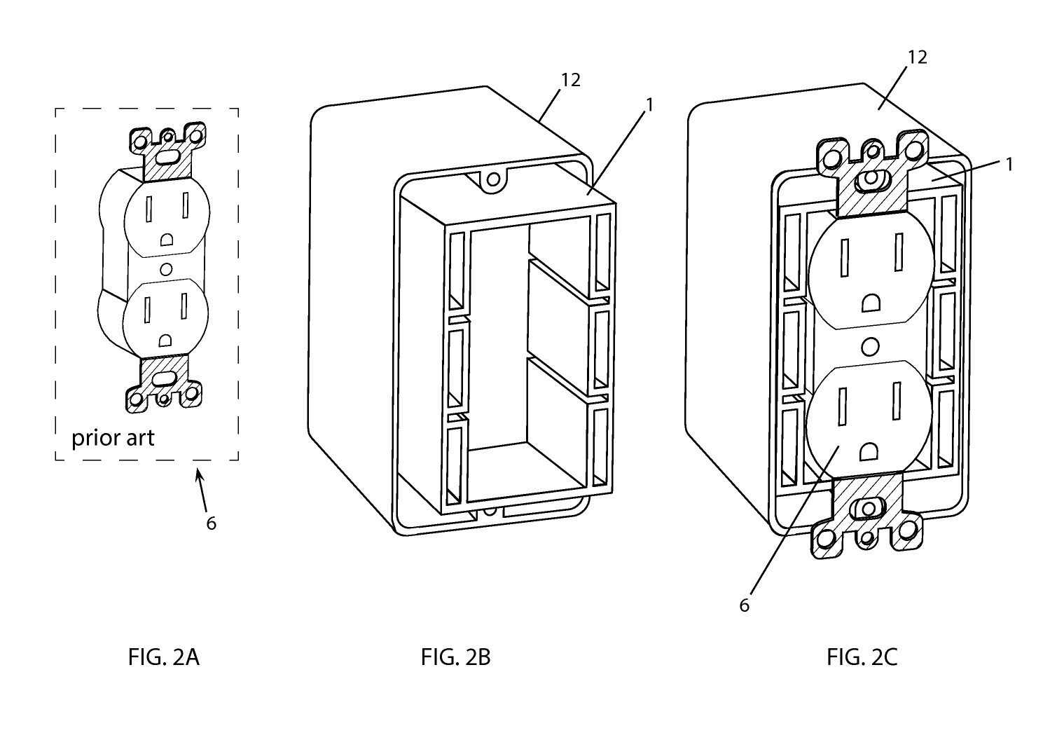

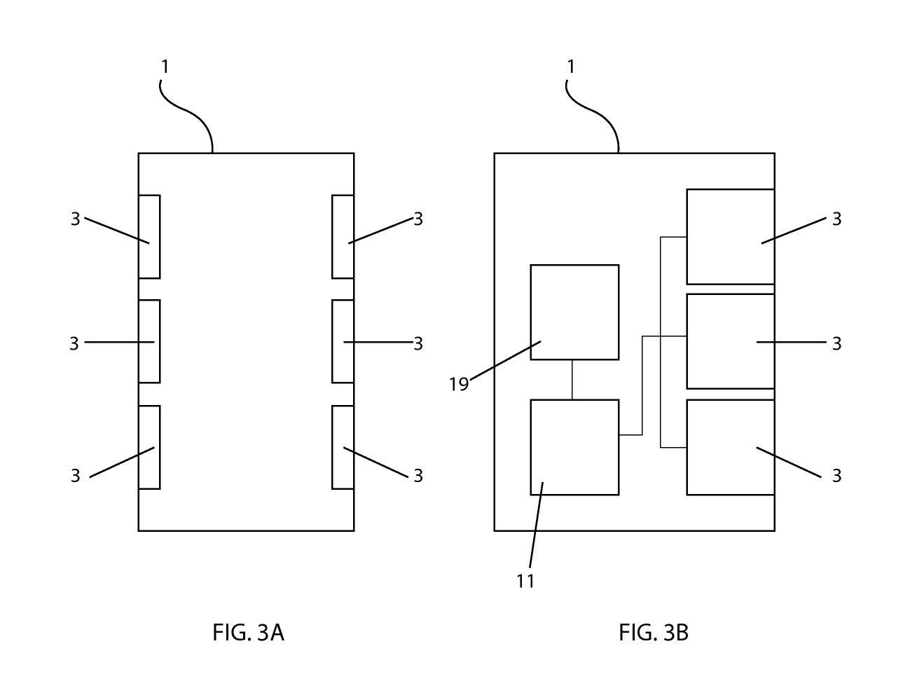

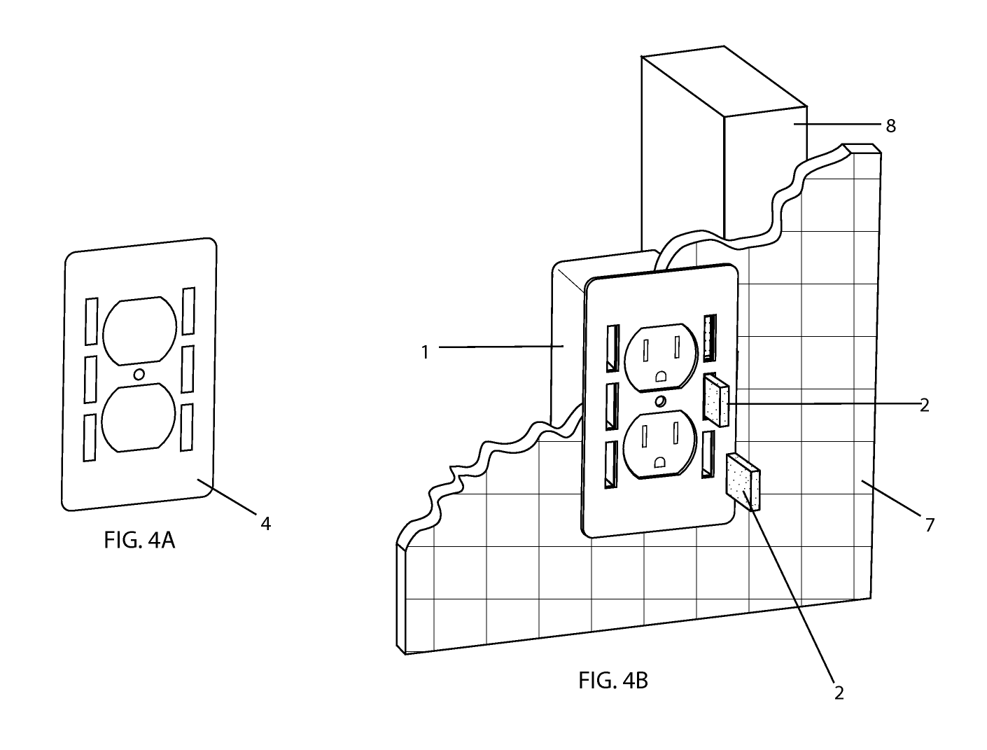

The preferred embodiment of the invention, as shown in FIGS. 2B and 3B, comprises a gang-box microcomputer 1, a power-supply, power converter and enables the use of interchangeable functional modules 2 as shown in FIG. 4B. The gang-box microcomputer 1, comprised of a micro-processor 11, a communications module and interface points 3. In the preferred embodiment, the interface parts specifically to accommodate modular functional units. In such embodiment, power conversion takes the form of an insert proportionally sized to fit within an existing electrical junction box 12 utilizing available power service while still providing electricity to the existing service or control point such as an outlet 6. Furthermore, this gang-box microcomputer 1 accepts modular devices adding specific functionalities including but not limited to wireless protocol, environmental sensors, audio/video recording, monitoring and outlet control.

In the preferred embodiment, the invention comprises a gang-box microcomputer 1 designed with a form factor so that a user may install it into an existing junction box. Such embodiment further comprises an electrical unit such as an outlet, switch or other electrical service or control point. The preferred embodiment allows for said electrical unit to be installed by the user without the need for wires by using mechanical contact points. The user may install the electrical unit by inserting and pressing said electrical unit, such as an outlet or light-switch, into a recess in the gang-box microcomputer 1 designed to accept such a device. The gang-box microcomputer 1, exhibiting this recess, hardwired in to the existing infrastructure of the building, allows for connectivity with the hub-unit by means of communication protocol, preferably over existing power lines, such as in the preferred embodiment by means of IEEE 1901 and/or HomePlug.

The gang-box microcomputer 1 senses and communicates data associated with environmental, visual, auditory and physical information within the space or room served by the gang-box microcomputer 1 and sensing devices. However, the user of the preferred embodiment of the invention has the option in such embodiment to utilize modular functional units to allow for the communication by other commonly known home automation and control communication protocols. It will be appreciated by one skilled in the art that commonly known home automation and control communication protocols include, but are not limited to the transmission of data over fiber-optics, computer networking cables, CAT6 cabling, phone lines, Wi-Fi, Bluetooth, Z-wave and Zigby. The protocols by which home automation and control take place continue to involve, thus the preferred embodiment of the invention is not limited to a particular protocol and may incorporate a variety of communication protocols to enable system functionality.

In this preferred embodiment of the invention, the hub-unit receives data communicated from individual gang-box microcomputers and analyzes the information based on pre-set algorithms set as factory defaults. Said pre-set algorithms can be modified by active input from the user or passive input or learning by the device though recognition of patterns and habits of the user within the space or room in which the system is deployed. As the number, type and location of functional capabilities throughout the home change through additional or modified installations, the algorithms are modified accordingly to accommodate such changed functional capabilities. The hub-unit applies such algorithms to provide actionable sequences and are executed in forms including but not limited to alerts to the user, actuation of system linked actuators or control of other controllers such as HVAC, light or power systems.

Furthermore, the hub-unit provides the user ability to activate or actuate any connected system as needed or desired by means of preprogramming or remote connection by phone, computer or other network enabled electronic communication device without the need to be within direct proximity of the system.

In another embodiment of the invention, the gang-box microcomputer is enabled to terminate power to the electrical service or control point installed to the gang-box microcomputer where a user desires to actively or automatically cut power for power saving reasons or for safety purposes such as a ground fault interrupt or maintenance purposes.

In practice, to utilize the preferred embodiment of the invention, a user installs a gang-box microcomputer 1 into an existing electrical junction or gang-box. The preferred embodiment utilizes existing power wires in parallel with the existing outlet 6 or control switch. The user may then insert one or more modular devices prior to reinstalling the cover-plate 4. The gang-box microcomputer 1, pursuant to this installation, has hard-wired power fully contained within the confines of an existing gang-box 12 without adversely impacting the aesthetics of the existing infrastructure. The resulting installation therefore provides for added home-automation and control without impeding the use of the existing service point or creating an unsightly or obtrusive aesthetic change in the process.

The gang-box microcomputer 1 allows for the insertion of a variety of functional modules 2. Each module is programmed and designed to add functionality to the system. A functional module 2 may incorporate a video camera for surveillance in one embodiment. Another embodiment of a functional module may take the form of a power consumption control and monitor unit. A module can be used to incorporate wireless functionality to enable communication with a smart phone or the internet, in the preferred embodiment via the Hub Unit, in addition to all other sensing capabilities.

In the preferred embodiment, the size of the module is standardized to enable interoperability. The standard size of a module in the preferred embodiment consists of the following sizes: 20 mm×20 mm, 20 mm×40 mm and 40 mm×40 mm and vary between 1 mm and 5 mm in thickness dependent upon their functionality. The port 3 or ports housed within the gang-box microcomputer is designed to accommodate the dimensions of the module.

In the preferred embodiment, the communication between the gang-box microcomputer 1 and the functional modules 2 uses a capacitive data communication protocol. Another embodiment of the invention incorporates a Micro-USB Type B female receptacle at a standardized location, designed to interact with a Micro-USB Type B male receptacle within a port 3 contained within a gang-box microcomputer 1. Further embodiments utilize a snap-in data wire connector type of connection. In addition to the methods of communication between the gang-box microcomputer and the functional modules 2 disclosed above, one skilled in the art will appreciated that such communication is enabled by a multitude of options available in the prior art surrounding computer data transfer protocols.

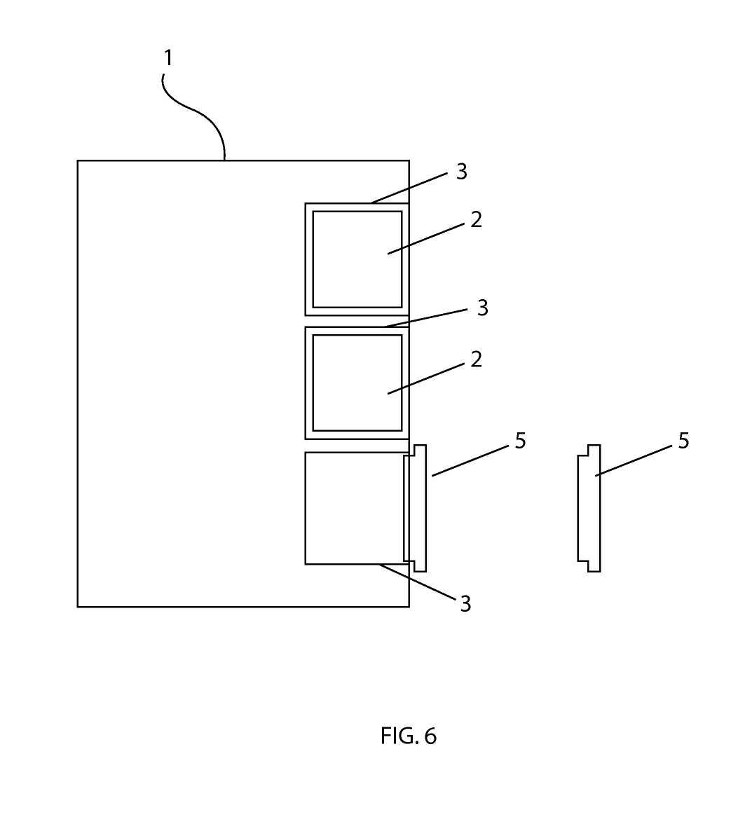

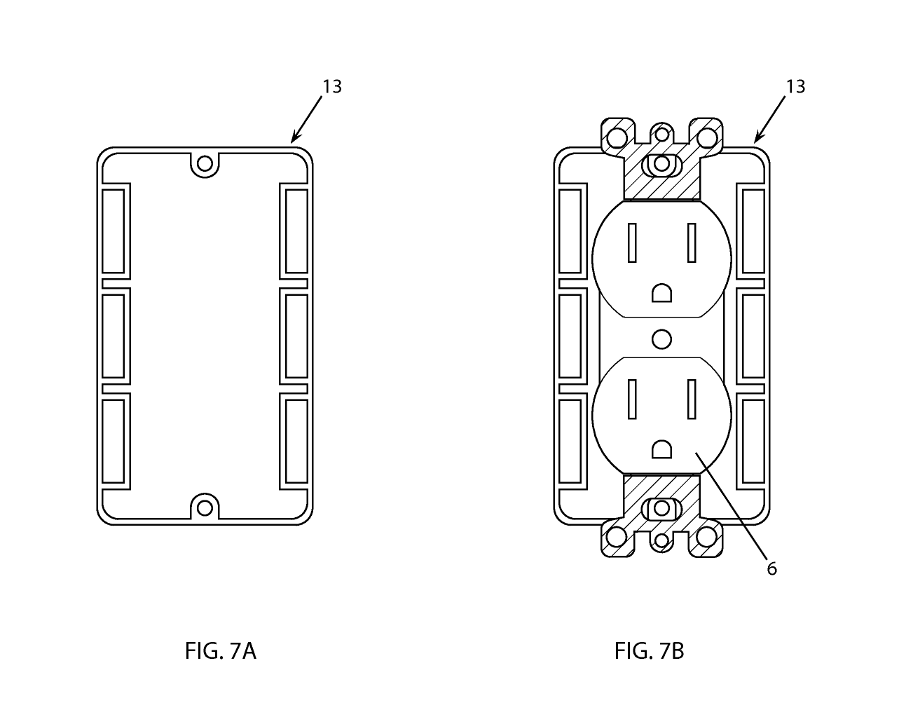

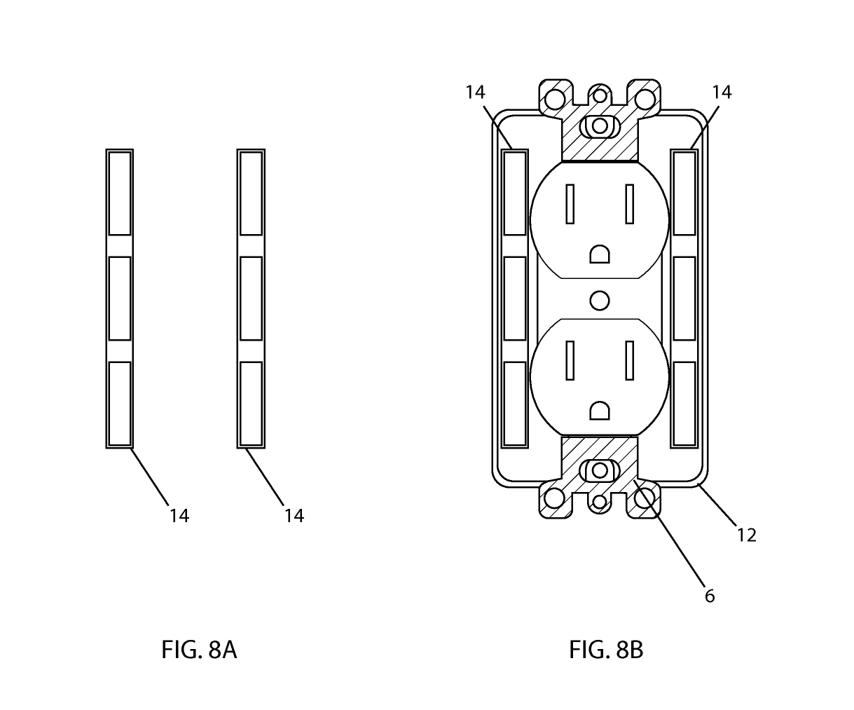

In another embodiment, as demonstrated in FIG. 4A and 6, the apparatus comprises of a gang-box microcomputer 1, a cover-plate 4, and cosmetic block-off inserts 5. A cover-plate 4, as utilized herein, refers to the component utilized in embodiments of invention to close in the chamber contained within gang-box 12 or the chamber contained within another apparatus similar to gang-box. A cosmetic block-off insert 5, as used herein, is an apparatus designed affix to the cover plate 4 to cover the functional module apertures 3 through which a module may pass.

In such embodiment, a gang-box microcomputer 1 is installed within an existing electrical junction box along with an existing electrical service or control point allowing for the utilization of the existing functionality. The cover-plate 4 incorporates functional module apertures 3 to allow for the installation of functional modules 2 without the removal of the cover-plate. Furthermore, a user may use cosmetic block-off inserts 5 to conceal the presence of holes through which a module may be inserted or to conceal modules after they have been inserted. The features of this embodiment allow the user to customize the overall functionality of the apparatus to their preference while still maintaining an inconspicuous installation.

The preferred embodiment incorporates a Hub Unit 20. The Hub Unit in the preferred embodiment interacts directly with the wireless signal emitter is integrated directly with the Hub Unit. The Hub Unit interfaces both with microcomputer sensors spread throughout the building in which it is installed, and also a cloud network to enable enhanced user control and computational functionality to enable automated control of the various nodes of the home automation and control network to which the Hub Unit is connected. In the preferred embodiment, the Hub Unit connects directly with an internet-connected router to enable network communications with the cloud network.

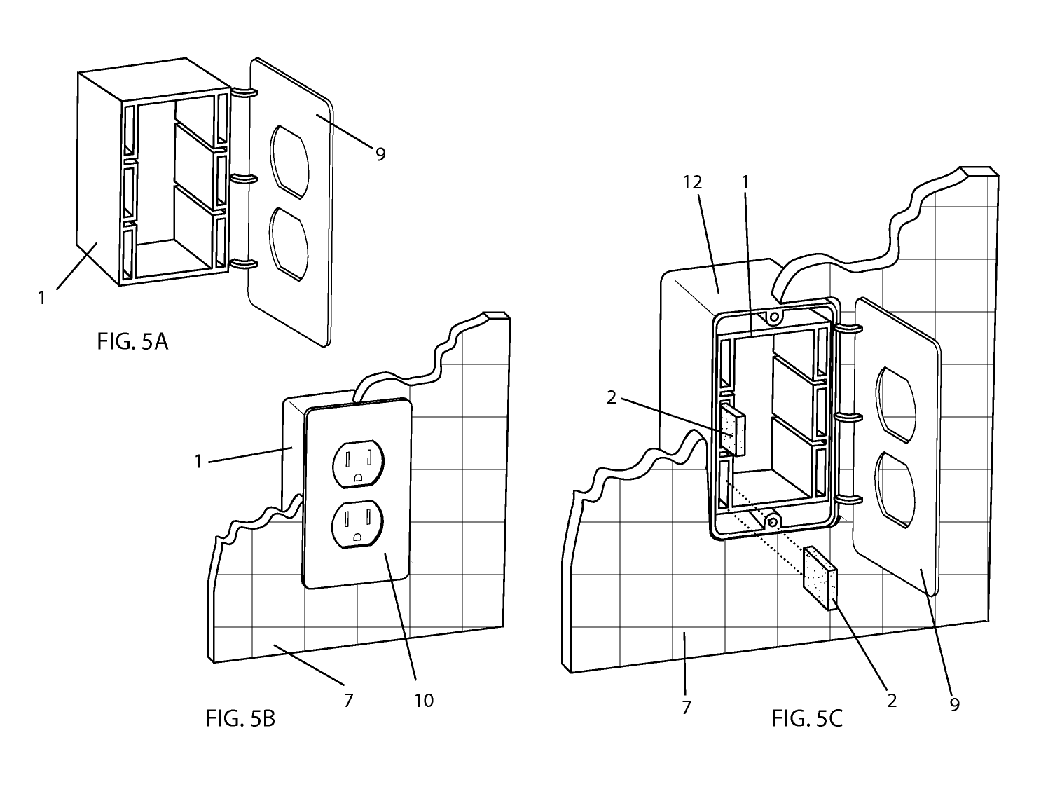

In another embodiment, as shown in FIG. 5C, the cover-plate 10 of the gang-box microcomputer exhibits no apertures or openings to allow the user to maintain complete inconspicuous installation while allowing for maximum functionality and modularity surrounding visual, auditory, environmental and physical sensing capabilities.

In an embodiment of the invention, the gang-box microcomputer 13 has integrated commonly used functionality including but not limited to communication protocols, power consumption monitoring and remote control of power supply. The gang-box microcomputer itself may incorporate functionality the necessary apparatus to utilize ZigBee, Z-Wave, Insteon and other commonly utilized home automation protocols. This allows the user to have levels of functionality without requiring additional functional modules. In alternative embodiments, the modules may incorporate functionality and the necessary apparatus to utilize alternative communication protocols not included within the device. The present inventor has discovered that in the preferred, it is preferable to incorporate the most commonly utilized communications protocols within the gang-box microcomputer, but to enable modules with the apparatus and programming to enable utilization of other communications protocols to augment the interoperability of the system. Likewise, the gang-box microcomputer still enables the use of functional modules to enhance and increase the functional capability of the apparatus with regard to power consumption monitoring, remote control of power supply and/or other home automation functionalities as desired by the user.

In an alternate embodiment, the cover-plate serves to enable additional functional module slots for expansion of functionality by means of directly connecting to the gang-box microcomputer using one or more functional module receptacles and increasing the total number of functional module ports by at least one port. This enables the user to expand the functionality of the system without the need to purchase and install an additional gang-box microcomputer unit.

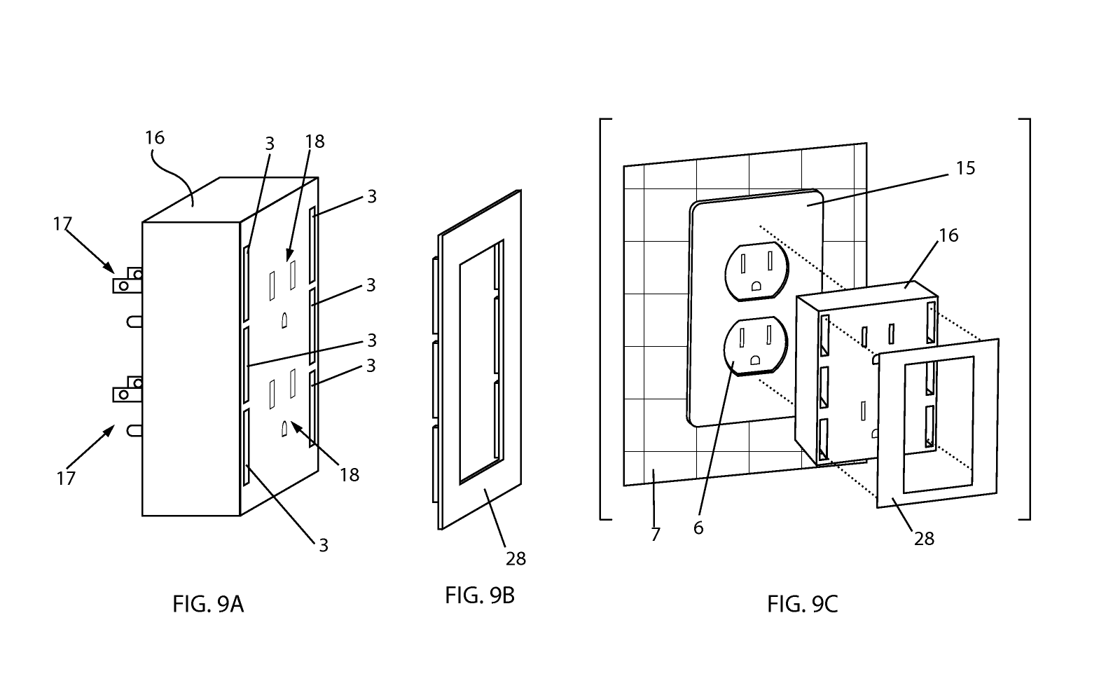

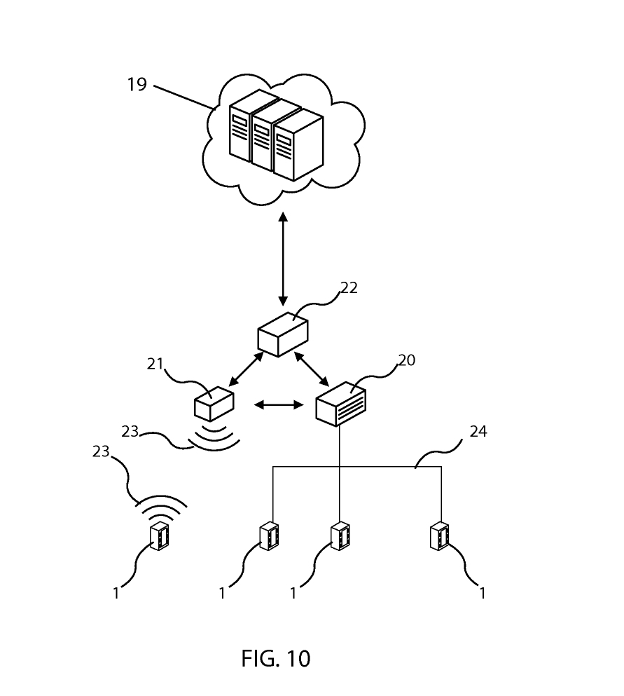

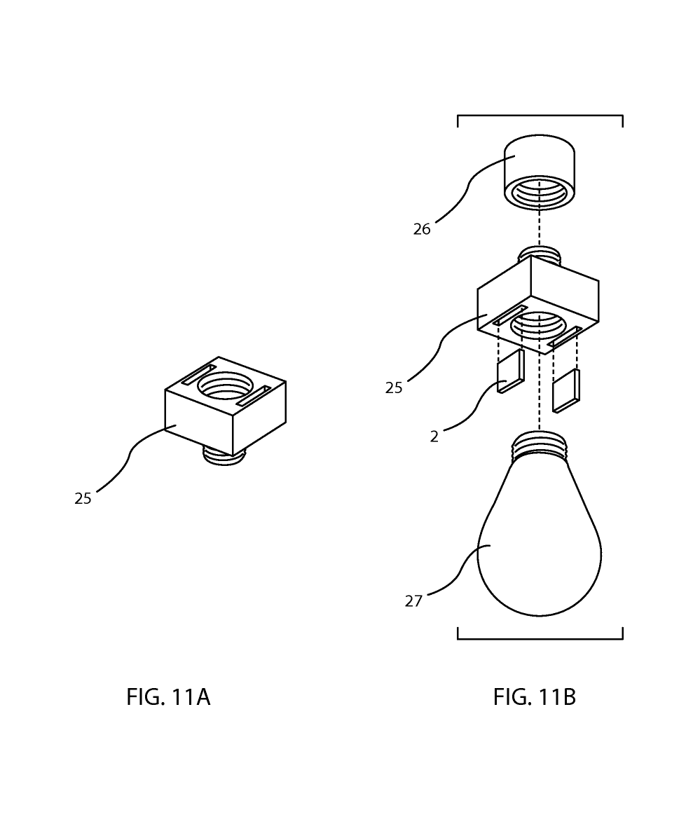

In an alternate scenario, the user may prefer to incorporate the functionality of a modular and customizable gang-box microcomputer without the need to install a gang-box microcomputer within an existing gang-box. Such a solution is provided with a device or gang-box microcomputer embodying the inventive concepts herein and enables plug-in gang-box microcomputer that utilizes and existing home power outlet as demonstrated in FIG. 9A and 9B. By simply plugging in such a unit 16 into an existing outlet, said unit provides the functional modularity and network communication capabilities associated with the inventive concepts described herein while minimizing the installation time and technical knowledge otherwise required to install a gang-box microcomputer within a gang-box. This embodiment provides the user ability to increase functionality with functional modules for sensing and communication purposes as described in prior embodiments.

In an alternate embodiment capturing the concepts of the invention, a microcomputer is integrated into a form referred to as a light-socket microcomputer 25 to enable the user to screw into a standardized light-socket 26 more generally intended for a light-bulb 27. In this alternate embodiment, the device incorporates interchangeable module receptacles to accommodate standardized units that provide smart-home automation, sensing and monitoring. Another alternative embodiment designed to interact with a standardized light-socket 26 incorporates automated smart home functionality directly within the unit without modular functionality. The light socket microcomputer incorporates sensing functionalities at the point of light socket installation to enable home automation and control in conjunction with other instances of related system apparatuses. An embodiment of the light socket microcomputer 25 includes integrated functionality including but not limited to power control, power monitoring and communications.

As with the integrated junction box embodiment of the invention, the preferred embodiment of the light socket microcomputer 25 interacts directly with the previously installed electrical wiring of the home and utilizes such electrical wiring to both power the device and communicate with other light-socket microcomputers and gang-box microcomputers throughout the home. One who is skilled in the art will appreciate that a variety of communications protocols, including but not limited to Universal Powerline Bus, LonTolk, and X10 and HomePlug, have been designed to communicate directly over power lines, which the preferred embodiment of the invention will utilize to communicate with other nodes while simultaneously receiving alternating current (AC) power to provide energy to the device.

Further embodiments of the light-socket microcomputer includes at least one receptacle for functional modules to increase the functional capability of the light-socket microcomputer unit surrounding sensing, monitoring, actuation, power control and other desired capabilities.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

What is claimed is:

1. A modular home automation device comprising a gang-box microcomputer having a main processor, a communications module, and at least one functional module.

2. The device of claim 1 wherein the functional module functions as one or more of an environmental sensing device, audio or video sensing, recording, or monitoring device, physical sensing device, and power shut-off device.

3. The device of claim 1 wherein the functional modules are removable and interchangeable.

4. The device of claim 2 wherein the environmental sensing devices monitors one or more of temperature, humidity, barometric pressure, weather changes, chemical or gas detection, air quality, smoke and other gasses.

5. The device of claim 2 wherein the audio or video sensing or recording device monitors one or more of cameras, motion-detection, depth-sensing, light intensity, wavelength, UV level, and microphones.

6. The device of claim 2 wherein the physical sensing device monitors one or more of contact pressure, structural integrity, and seismic activity.

7. The device of claim I further comprising a faceplate having a form factor so as to permit the installation and exchange of functional, modules.

8. The device of claim 1 wherein the gang-box microcomputer has a form factor sized to fit within a standard junction box without displacing the existing service or control such as an outlet or switch.

9. The device of claim 1, further comprising a hub-unit.

10. The device of claim 9, wherein the at least one functional module provides status, data and other information to the hub-unit.

11. The device of claim 9, wherein the hub-unit provides communication with a network or cloud-based system to provide remote control of the system.

12. The device of claim 9, wherein the hub-unit provides communication with a network or cloud-based system to provide remote control of the system.

13. A device for home automation and control, comprising a gang-box microcomputer, power-supply, power converter, and one or more receptacles for one or more functional modules.

14. The device of claim 13, wherein the gang-box microcomputer comprises a micro-processor, a communications module, and one or more interface points.

15. The device of claim 14, wherein the one or more interface points accommodate one or more modular functional units.

16. The device of claim 15, wherein the one or more modular functional units comprise one or more of wireless protocols, environmental sensors, audio or video recording, monitoring, and outlet control.

17. A device for home automation and control, comprising a gang-box microcomputer having a form factor fitting inside an existing electrical junction box.

18. The device of claim 17, wherein the device is hardwired in to the existing electrical infrastructure of a building.

19. The device of claim 18. wherein the device connects with a hub-unit by means of a communication protocol.

20. The device of claim 19, wherein the communication protocol is over existing power lines.
